(19) United States
(12) Patent Application Publication
(10) Pub. No.: US 2026/0243715 A1
(43) Pub. Date: Aug. 20, 2026

(54) THERMAL INTERFACE MATERIAL TESTER

(71) Applicant: NVIDIA CORPORATION, Santa Clara, CA (US)

(72) Inventors: Andrew Huy LAM, San Jose, CA (US); Malcolm Brosnahan GUTENBURG, San Francisco, CA (US); Shahin AMIRI, Santa Clara, CA (US); Victor Sharbel HONEIN, Fremont, CA (US); Amit KULKARNI, San Jose, CA (US)

(21) Appl. No.: 19/054,450

(22) Filed: Feb. 14, 2025

(51) Int. Cl. G01N 25/16

(52) U.S. Cl. CPC G01N 25/16

(57) ABSTRACT

Techniques for thermal interface material testing are described. In one example, a thermal interface material testing device includes a bimaterial strip, a pressure plate that applies a pressure to a thermal interface material between the pressure plate and the bimaterial strip, one or more thermal cycling devices that perform thermal cycling of the bimaterial strip to test the thermal interface material, and one or more sensor devices that generate sensor data based on the thermal cycling of the bimaterial strip.

### BACKGROUND

### Technical Field

Embodiments of the present disclosure relate generally to thermal interface material testing, and, more specifically, to techniques for providing a thermal interface material tester.

### Description of the Related Art

Thermal interface materials are used as gap fillers in an interface area between the two mating surfaces that exchange heat, such as an interface area between a semiconductor device and a heatsink. Because the thermal interface material conducts heat better than, for example, air or a void, the heat transfer is improved. However, semiconductor devices can cyclically warp over time, which can cause degradation and pump-out of the thermal interface material. The thermal interface material degradation and pump-out can introduce voiding, delamination, and/or other irregularities within the interface area. Air is a poor thermal conductor, and, consequently, air gaps caused by the aforementioned voiding can restrict the amount of heat that the heatsink can effectively extract. Accordingly, characterizing how a thermal interface material voids as the semiconductor device undergoes thermal and power cycling can be useful.

One drawback to traditional thermal interface material testing approaches is that the traditional approaches use actual semiconductor devices (e.g., a board, a chip, a die, etc.) to test thermal interface materials. Specifically, a semiconductor device is heated and cooled by system-level power cycling that places the semiconductor device under a workload of varying power. In some cases, the semiconductor device is even placed within a thermal chamber. Notably, it can be difficult to produce, obtain, etc., many units of the semiconductor device for traditional thermal interface material testing. As a result, the testing of multiple thermal interface materials cannot be performed until the semiconductor device enters a production phase. Moreover, parallel testing of various thermal interface materials is limited to the number of actual semiconductor devices that are available for testing. Another drawback to traditional thermal interface material testing involving the actual semiconductor device is that providing the semiconductor device to testing entities introduces a security risk. As a result, some enterprises limit testing to internal groups, associated enterprises, or an otherwise limited number of testing entities, which can reduce the overall amount of knowledge that can be gleaned from thermal interface material testing processes.

As the foregoing illustrates, what is needed in the art are more effective techniques for performing thermal interface material testing.

### SUMMARY

One embodiment of the present disclosure sets forth a thermal interface material testing system that includes a pressure plate, a bimaterial strip, a thermal interface material between the pressure plate and the bimaterial strip, one or more thermal cycling devices that perform thermal cycling of the bimaterial strip to test the thermal interface material, and one or more sensor devices that generate sensor data based on the thermal cycling of the bimaterial strip.

Further embodiments of the present disclosure set forth a thermal interface material testing device, that includes a bimaterial strip, a pressure plate that applies a pressure to a thermal interface material between the pressure plate and the bimaterial strip, one or more thermal cycling devices that perform thermal cycling of the bimaterial strip to test the thermal interface material, and one or more sensor devices that generate sensor data based on the thermal cycling of the bimaterial strip.

Further embodiments of the present disclosure set forth a method that includes generating thermal interface material testing configuration data including instructions to assemble and operate a thermal interface material testing device to test thermal interface materials, where the thermal interface material testing device comprises a pressure plate, a bimaterial strip, one or more thermal cycling devices, and one or more sensor devices; and transmitting the thermal interface material testing configuration data to one or more networked computing devices, for example, to perform tests for one or more thermal interface materials.

At least one technical advantage of the disclosed techniques relative to the prior art is that the disclosed techniques enable the suitability of a thermal interface material for an electronic component or thermal regulation component to be tested without using the physical component. The disclosed techniques further enable multiple thermal interface materials to be tested in parallel, for example, prior to a production phase of the physical component. The disclosed techniques further enable thermal interface materials to be tested by any number of enterprises in relation to the physical component without exposing the physical component to security risks such as reverse engineering. These technical advantages represent one or more technological improvements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates an exploded view of an exemplary thermal interface material testing device, according to various embodiments;

FIG. 2 illustrates an exploded view of a portion of a thermal interface material testing device that tests thermal interface materials for an electronic component, according to various embodiments;

FIG. 3 illustrates an exploded view of a portion of a thermal interface material testing device that tests thermal interface materials for a thermal regulation component, according to various embodiments;

FIG. 4 illustrates an exploded view of an exemplary thermal interface material testing device that uses an acoustic imaging device, according to various embodiments;

FIG. 5 illustrates a thermal interface material testing system, according to various embodiments;

FIG. 6A illustrates exemplary image data generated using the thermal interface material testing device of FIG. 1, according to various embodiments;

FIG. 6B illustrates exemplary image data image data generated using the thermal interface material testing device of FIG. 4, according to various embodiments;

FIG. 7A is a flow diagram of method steps for generating thermal interface material testing data, according to various embodiments;

FIG. 7B is a flow diagram of method steps for selecting thermal interface materials tested using the thermal interface material testing system of FIG. 5, according to various embodiments; and

FIG. 8 is a block diagram illustrating a computer system for use with the thermal interface material testing system of FIG. 5 and the thermal interface material testers of FIGS. 1 and 4, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

### System Overview

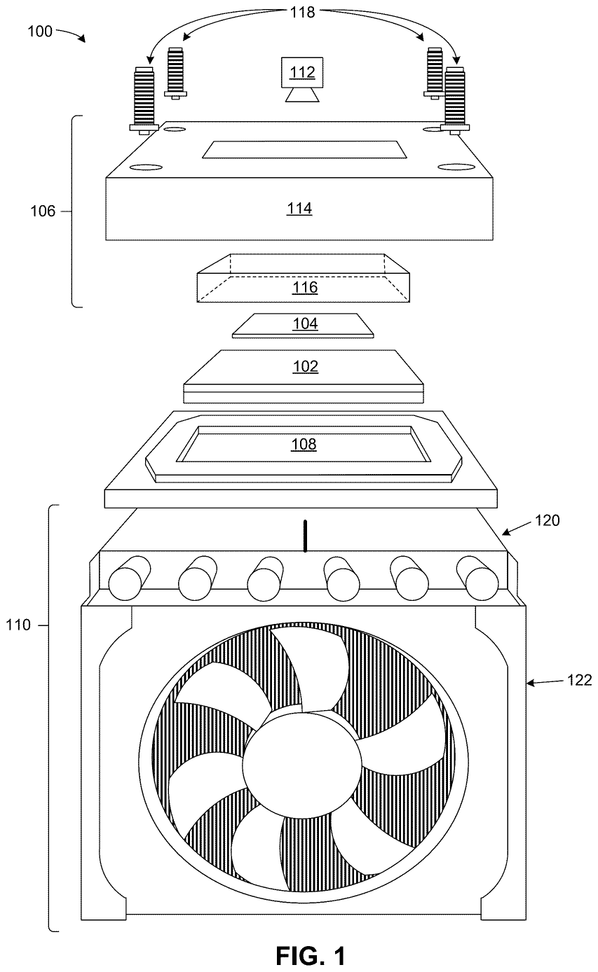

FIG. 1 illustrates an exploded view of an exemplary thermal interface material testing device 100, according to various embodiments. The thermal interface material testing device 100 includes, without limitation, a bimaterial strip 102, a thermal interface material 104, a pressure plate assembly 106, a stencil 108, one or more thermal cycling devices 110 (or an assembly), as well as one or more sensors including an optical imaging device 112. The pressure plate assembly 106 includes, without limitation, a pressure plate frame 114, a transparent pressure plate 116, and one or more compression components 118. The thermal cycling device 110 includes, without limitation, a heating component 120 and a cooling component 122.

The bimaterial strip 102 includes a strip that is made of two different materials that expand and/or contract and different rates when heated and/or cooled, which causes mechanical displacement such as bending. In some embodiments, the bimaterial strip 102 includes a bimetallic strip that includes two different metals. However, in some embodiments, a bimaterial strip 102 includes a material such as a semiconductor material, a polymer material, and/or the like.

The bimaterial strip 102 (and the thermal cycling device 110) is utilized to emulate the behavior of a component such as an electronic component, a thermal regulation component, or another component of a device or computing system. A computing system can include electronic components such as one or more processors, one or more coprocessors, one or more network connectors, and/or the like. In some embodiments, a respective one of the processors, coprocessors, and network connectors includes a corresponding thermal regulation component. In various embodiments, the thermal regulation components include passive and/or active components such as heatsinks, fans, liquid cooling components, and/or the like.

In some embodiments, the bimaterial strip 102 is utilized as a stand in for a chip, a die, and/or other electronic components that use a thermal interface material 104. In some embodiments, the bimaterial strip 102 is utilized as a stand in for a heatsink, a liquid cooling plate, and/or other thermal regulation components that use a thermal interface material 104. The two materials of the bimaterial strip 102 are selected such that the mechanical displacement parameters or properties of the bimaterial strip 102 are based on (e.g., matches or is within a threshold difference from) mechanical displacement parameters of the physical component. In various embodiments, displacement parameters include one or more displacements (e.g., distance relative to a surface of a pressure plate, stencil 108, and/or thermal cycling device 110) at one or more configured temperatures and locations. In some examples one or more displacement is measured at a maximum expected temperature for the component, and one or more displacement is measured at a minimum expected temperature for the component or type of component.

In some embodiments, one or more dimensions of the bimaterial strip 102 matches that of a component that the bimaterial strip 102 emulates. For example, a length and width of the bimaterial strip 102 matches a length and width of the component. In various embodiments, the thickness of the bimaterial strip 102 matches that of the component. Alternatively, the thickness of the bimaterial strip 102 differs from the component, for example, so that the bimaterial strip 102 achieves similar (e.g., within a threshold) displacement parameters of the physical component.

The thermal interface material 104 includes any material that is deployed between mating surfaces of two components to enhance the thermal coupling between the components. Thermal interface materials 104 include, without limitation, thermal pastes, thermal greases, thermal gels, and/or the like. In some embodiments, a thermal interface material 104 includes graphite, metal, and/or other thermally conductive materials. The various different types of thermal interface materials 104 can have different properties that cause differing patterns of degradation for differing temperature ranges and displacement ranges. A thermal interface material 104 is associated with one or more parameters such as a thermal expansion coefficient and a stiffness, among others. The thermal expansion coefficient refers to a change in length or volume per unit temperature change. A thermal interface material 104 that maintains greater contact area and/or lesser voiding/delaminated/degraded area in the interface area is identified as preferable to another thermal interface material 104 that maintains lesser contact area and/or greater degraded area.

The stencil 108 holds the bimaterial strip 102 in place laterally. In some embodiments, the stencil 108 includes a cavity into which the bimaterial is placed or inserted. The cavity of the stencil 108 matches a length and width (and in some examples a thickness) of the bimaterial strip 102. In some embodiments, the stencil 108 is mechanically connected to the thermal cycling device 110.

The optical imaging device 112 can include an optical camera device capable of capturing still and/or video images. The images show the thermal interface material 104 over the course of testing, including images before, during, and after thermal cycling. The images show any voids or gaps in the thermal interface material 104 over the course of testing. In some embodiments, the thermal interface material testing device 100 identifies thermal interface material data based on the images or image data captured using the optical imaging device 112. While not shown, additional sensors can include one or more displacement (or proximity)sensors, one or more thermocouples, and/or the like. Displacement and/or proximity sensors can include optical devices, including laser-based devices, magnetic devices, and/or the like. A displacement sensor measures displacement, for example, of one or more locations of the bimaterial strip 102.

The pressure plate assembly 106 includes a pressure plate frame 114, a transparent pressure plate 116, and one or more compression components 118. The pressure plate frame 114 includes a center opening so that the optical imaging device 112 observes thermal interface material 104 through the transparent pressure plate 116. The pressure plate frame 114 and the transparent pressure plate 116 provide an optical window for direct optical imaging. While referred to as quartz in some embodiments, the transparent pressure plate 116 can alternatively be made of another optically transparent or translucent material. Opaque materials such as metals can also be used, including materials that are the same as a heatsink for an electronic component. Where opaque materials are used, the optical imaging device 112 can be a non-optical imaging device such as a magnetic imaging device, an acoustic imaging device, and/or the like.

The compression components 118 include spring screws, leaf springs, and/or the like. The compression components 118 apply pressure so that the thermal interface material 104 is sandwiched between the transparent pressure plate 116 and the bimaterial strip 102 at a configured pressure. The pressure applied using the compression components 118 is configured to match (e.g., within a threshold) an expected pressure for the component that the bimaterial strip 102 emulates in association with the thermal cycling device 110.

The thermal cycling device 110 includes the heating component 120 and the cooling component 122. While referred to as a single device, the heating component 120 and the cooling component 122 can be separate thermal cycling devices 110 controlled in conjunction with one another to perform thermal cycling, or a single thermal cycling device 110 that performs both heating and cooling for thermal cycling. As a result, one or more thermal cycling devices 110 of the thermal interface material testing device 100 heat and cool the bimaterial strip 102 to perform thermal cycling according to one or more thermal cycling parameters. The thermal cycling parameters can match one or more temperature properties or parameters of a component that the bimaterial strip 102 emulates. For example, the one or more thermal cycling devices 110 heats the bimaterial strip 102 up to a configured temperature such as a slowdown temperature or other temperature corresponding to an operational limit of the component. In traditional systems, testing at temperatures over the slowdown temperature of the component can damage the component and/or compromise the testing process. However, the techniques described enable testing at temperatures exceeding one or more operational limits (e.g., a slowdown temperature) of the component being emulated by the bimaterial strip 102. In some embodiments, the one or more thermal cycling devices 110 heats the bimaterial strip 102 at a configured rate. The one or more thermal cycling devices 110 also cools the bimaterial strip 102 to a configured lower-level temperature. In some examples, the one or more thermal cycling devices 110 cools the bimaterial strip 102 at a configured rate. The one or more thermal cycling devices 110 performs a configurable number of heating and/or cooling cycles of the bimaterial strip 102.

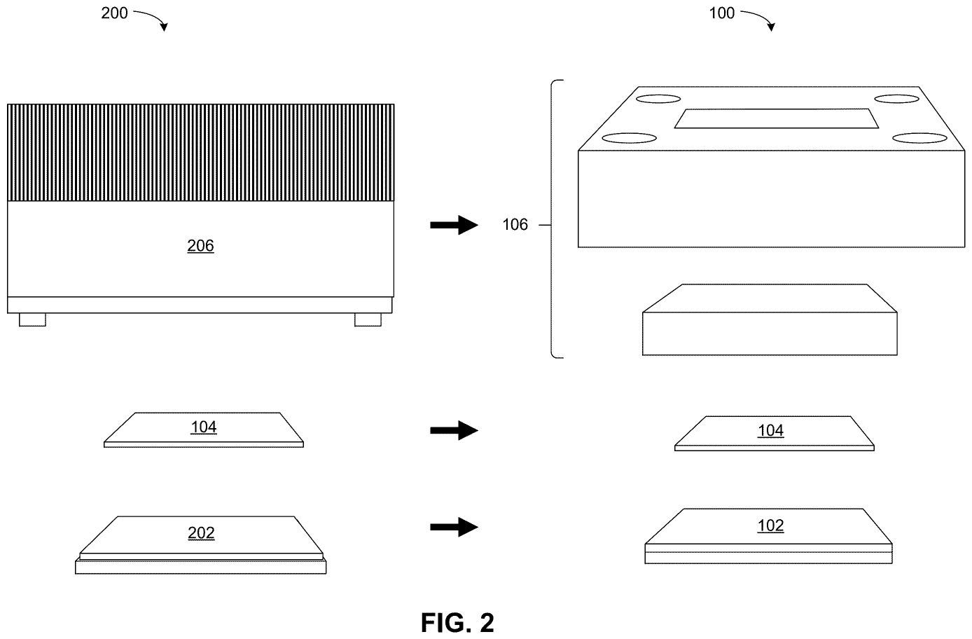

FIG. 2 illustrates an exploded view of a portion of a thermal interface material testing device 100 that tests thermal interface materials 104 for an electronic component 202, according to various embodiments. FIG. 2 shows a portion of the thermal interface material testing device 100 including the bimaterial strip 102, a thermal interface material 104, and at least a portion of a pressure plate assembly 106. The figure also shows a component assembly 200 that includes an electronic component 202, a thermal interface material 104, and a heatsink or thermal regulation device 206.

In this example, the thermal interface material testing device 100 uses the bimaterial strip 102 to emulate the electronic component 202. In such an example, the pressure plate assembly 106 operates as a stand-in for the thermal regulation device 206. Parameters or properties of the bimaterial strip 102 are based on (e.g., matches or is within a threshold difference from) mechanical displacement parameters of the electronic component 202. The pressure plate assembly 106 compresses the thermal interface material 104 against the bimaterial strip 102 at a configured pressure that matches pressure that the thermal regulation device 206 applies to the electronic component 202.

The thermal interface material testing device 100 is configurable to test one or more thermal interface materials 104 for use with an electronic component 202 using multiple different pressure plate assemblies 106 (and/or different compression components 118, not shown). In the configuration shown, the pressure plate assembly 106 provides an optical imaging window for direct optical imaging. However, multiple different pressure plate assemblies can be used such as an opaque pressure plate assembly 106 that matches a material and/or size and shape of the thermal regulation device 206. An opaque pressure plate assembly 106 can be used in conjunction with acoustic imaging or other non-optical imaging techniques and corresponding non-optical imaging devices.

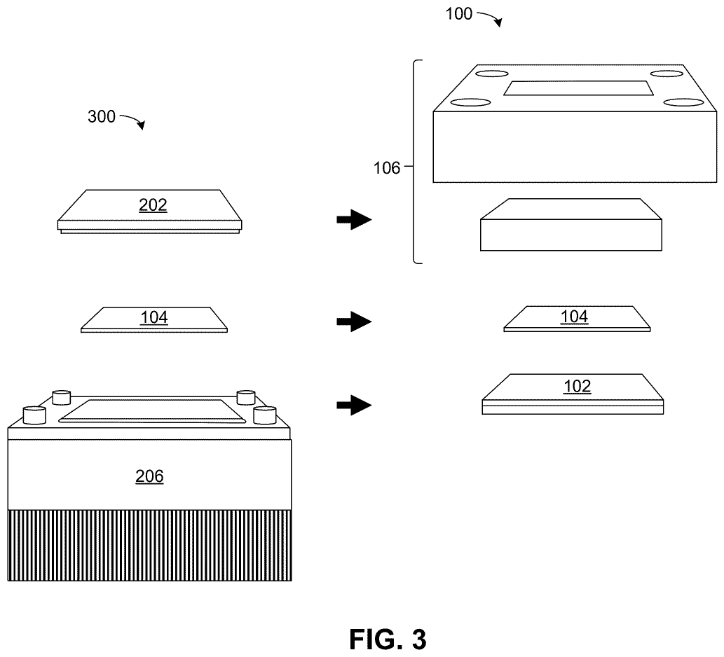

FIG. 3 illustrates an exploded view of a portion of a thermal interface material testing device 100 that tests thermal interface materials 104 for a thermal regulation device 206, according to various embodiments. FIG. 3 shows a portion of the thermal interface material testing device 100 including the bimaterial strip 102, a thermal interface material 104, and at least a portion of a pressure plate assembly 106. The figure also shows a component assembly 300 that includes an electronic component 202, a thermal interface material 104, and a heatsink or thermal regulation device 206.

By contrast with FIG. 2, the thermal interface material testing device 100 of FIG. 3 uses the bimaterial strip 102 to emulate the thermal regulation device 206. In the example of FIG. 3, the pressure plate assembly 106 operates as a stand-in for the electronic component 202. Parameters or properties of the bimaterial strip 102 are based on (e.g., matches or is within a threshold difference from) mechanical displacement parameters of the thermal regulation device 206. The pressure plate assembly 106 compresses the thermal interface material 104 against the bimaterial strip 102 at a configured pressure that matches pressure the thermal regulation device 206 applies to the electronic component 202.

The thermal interface material testing device 100 is configurable to test one or more thermal interface materials 104 for use with the thermal regulation device 206. Various configurations include using multiple different pressure plate assemblies 106 (and/or different compression components 118, not shown). In the configuration shown, the pressure plate assembly 106 provides an optical window for direct optical imaging. However, multiple different pressure plate assemblies can be used such as an opaque pressure plate assembly 106 that matches a material and/or size and shape of the electronic component 202. An opaque pressure plate assembly 106 can be used in conjunction with acoustic imaging or other non-optical imaging techniques and corresponding non-optical imaging devices.

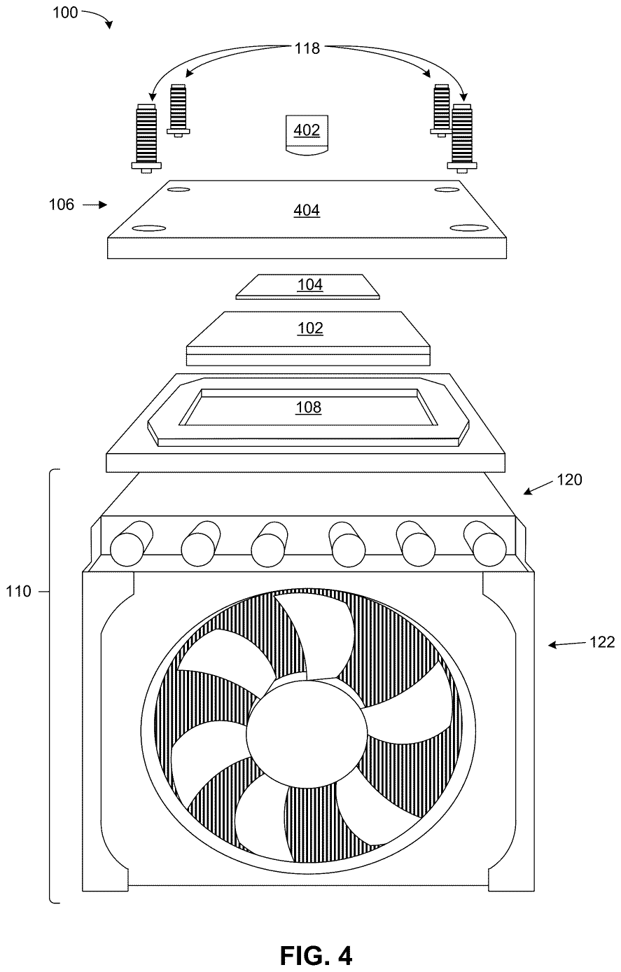

FIG. 4 illustrates an exploded view of an exemplary thermal interface material testing device 100 that uses a non-optical imaging device 402, according to various embodiments. The thermal interface material testing device 100 includes, without limitation, a bimaterial strip 102, a thermal interface material 104, a pressure plate assembly 106, a stencil 108, one or more thermal cycling devices 110 (or an assembly), as well as one or more sensors including a non-optical imaging device 402. The pressure plate assembly 106 includes, without limitation, an opaque pressure plate 404 and one or more compression components 118. The thermal cycling device 110 includes, without limitation, a heating component 120 and a cooling component 122.

The bimaterial strip 102 includes a strip that is made of two different materials that expand and/or contract and different rates when heated and/or cooled, causing mechanical displacement such as bending. The bimaterial strip 102 (and the thermal cycling device 110) is utilized to emulate the behavior of a component such as an electronic component, a thermal regulation component, or another component of a device or computing system. In some embodiments, the bimaterial strip 102 is utilized as a stand in for a chip, a die, and/or other electronic components that use a thermal interface material 104. In some embodiments, the bimaterial strip 102 is utilized as a stand in for a heatsink, a liquid cooling plate, and/or other thermal regulation components that use a thermal interface material 104. The two materials of the bimaterial strip 102 are selected such that the mechanical displacement parameters or properties of the bimaterial strip 102 are based on (e.g., matches or is within a threshold difference from) mechanical displacement parameters of the physical component. In some embodiments, one or more dimensions of the bimaterial strip 102 matches that of a component that the bimaterial strip 102 emulates.

The thermal interface material 104 includes any material that is deployed between mating surfaces of two components in order to enhance the thermal coupling between the components. Thermal interface materials 104 include, without limitation, thermal pastes, thermal greases, thermal gels, and/or the like. In some embodiments, a thermal interface material 104 includes graphite, metal, and/or other thermally conductive materials.

The stencil 108 holds the bimaterial strip 102 in place laterally. In some embodiments, the stencil 108 includes a cavity into which the bimaterial is placed or inserted. The cavity of the stencil 108 matches a length and width (and in some examples a thickness) of the bimaterial strip 102. In some embodiments, the stencil 108 is mechanically connected to the thermal cycling device 110.

In some embodiments, the non-optical imaging device 402 includes an acoustic imaging device that performs scanning acoustic microscopy (C-SAM), acoustic micro imaging (AMI), scanning acoustic tomography (SAT), and/or the like. In some embodiments, the non-optical imaging device 402 includes a magnetic imaging device or another type of imaging device. The non-optical imaging device 402 is capable of two-dimensional and/or three-dimensional imaging of the thermal interface material 104 (e.g., showing and reproducing degradation patterns including voiding, delamination and/or the like) and/or the bimaterial strip 102 (e.g., showing and reproducing displacement distances). The non-optical imaging device 402 does not require an optically transparent or translucent window. As a result, the pressure plate assembly 106 of FIG. 4 includes an opaque pressure plate 404.

The opaque pressure plate 404 can include a copper, aluminum, semiconductor, or other material selected to enable acoustic imaging and/or to emulate a physical component. The compression components 118 include spring screws, leaf springs, and/or the like. The compression components 118 apply pressure so that the thermal interface material 104 is sandwiched between the opaque pressure plate 404 and the bimaterial strip 102 at a configured pressure. The pressure applied using the compression components 118 is configured to match (e.g., within a threshold) an expected pressure for the component that the bimaterial strip 102 emulates in association with the thermal cycling device 110.

The thermal cycling device 110 includes the heating component 120 and the cooling component 122. While referred to as a single device, the heating component 120 and the cooling component 122 can be separate thermal cycling devices 110 controlled in conjunction with one another to perform thermal cycling, or a single thermal cycling device 110 that performs both heating and cooling for thermal cycling. As a result, one or more thermal cycling devices 110 of the thermal interface material testing device 100 heat and cool the bimaterial strip 102 to perform thermal cycling according to one or more thermal cycling parameters. The thermal cycling parameters can match one or more temperature properties or parameters of a component that the bimaterial strip 102 emulates. For example, the one or more thermal cycling devices 110 heats the bimaterial strip 102 up to a configured temperature such as a slowdown temperature or other temperature corresponding to an operational limit of the component. In traditional systems, testing at temperatures over the slowdown temperature of the component can damage the component and/or compromise the testing process. However, the techniques described enable testing at temperatures that exceed one or more operational limits (e.g., a slowdown temperature) of the component being emulated by the bimaterial strip 102. In some embodiments, the one or more thermal cycling devices 110 heats the bimaterial strip 102 at a configured rate. The one or more thermal cycling devices 110 also cools the bimaterial strip 102 to a configured lower-level temperature. In some examples, the one or more thermal cycling devices 110 cools the bimaterial strip 102 at a configured rate. The one or more thermal cycling devices 110 performs a configurable number of heating and/or cooling cycles of the bimaterial strip 102.

While the thermal interface material testing device 100 tests one or more thermal interface materials 104 for an electronic component 202, the thermal interface material testing device 100 can also identify information about a surface against which the electronic component 202 is pressed. In some embodiments the thermal interface material testing device 100 images a surface of the opaque pressure plate 404 and identifies information that indicates how the opaque pressure plate 404 holds up to the thermal cycling operation in association with the thermal interface material 104 under test, and the bimaterial strip 102 corresponding to a first physical device component such as a chip or die. The opaque pressure plate 404 can have a material, shape, thickness, and/or other properties associated with a second physical device component

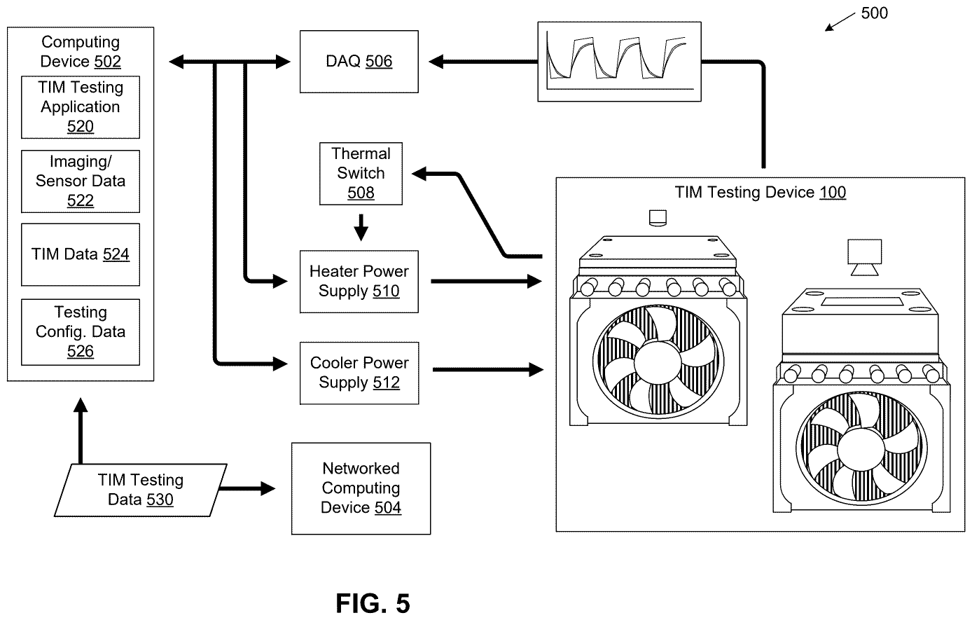

FIG. 5 illustrates a thermal interface material testing system, according to various embodiments. The thermal interface material testing system 500 includes, without limitation, a thermal interface material testing device 100, a computing device 502, a networked computing device 504, a data acquisition device 506, thermal switch 508, a heater power supply 510, and a cooler power supply 512. The computing device 502 stores, executes and/or otherwise utilizes, without limitation, a thermal interface material testing application 520, imaging and/or other sensor data 522, thermal interface material data 524, and testing configuration data 526. The computing device 502 and/or the networked computing device 504 communicates (e.g., transmits and/or receives) one or more portions of the thermal interface material testing data 530.

In various embodiments, the computing device 502 includes any type of device, including, without limitation, a controller system, a server machine, a server platform, a desktop machine, a laptop machine, a hand-held/mobile device, a digital kiosk, and/or one or more devices in a distributed computing system. The computing device 502 includes, without limitation, a processor, a network interface, and a memory.

The processor includes any technically feasible processing device configured to process data and execute program instructions. For example, processor could include an application specific integrated circuit (ASIC). Other non-limiting examples of the processing circuitry include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs.

The memory corresponds to any suitable type of memory device or collection of memory devices configured to store instructions. Non-limiting examples of suitable memory devices that can be used include Flash memory, Random Access Memory (RAM), Read Only Memory (ROM), variants thereof, combinations thereof, or the like. In some embodiments, the memory and processor may be integrated into a common device (e.g., a microprocessor may include integrated memory). Additionally, or alternatively, the processing circuitry may comprise hardware, such as an application specific integrated circuit (ASIC). Other non-limiting examples of the processing circuitry include an Integrated Circuit (IC) chip, a Central Processing Unit (CPU), a General Processing Unit (GPU), a microprocessor, a Field Programmable Gate Array (FPGA), a collection of logic gates or transistors, resistors, capacitors, inductors, diodes, or the like. Some or all of the processing circuitry may be provided on a Printed Circuit Board (PCB) or collection of PCBs.

In various embodiments, the networked computing device 504 includes any type of device, including, without limitation, a controller system, a server machine, a server platform, a desktop machine, a laptop machine, a hand-held/mobile device, a digital kiosk, and/or one or more devices in a distributed computing system. The networked computing device 504 includes, without limitation, a processor, a network interface, and a memory, for example, as described in relation to the computing device 502. It should be appreciated that each of the computing device 502 and the networked computing device 504 can include any processors, memories, and/or network interfaces generally associated with computing tasks, such as sending and receiving data.

The data acquisition device 506 includes any feasible device that receives information from the imaging and other sensors of the thermal interface material testing device 100, and processes and/or converts the information for use by the computing device 502. While shown as a separate component from the computing device 502, the data acquisition device 506 can also be a subcomponent of the computing device 502. Some examples of the data acquisition device 506 include one or more analog to digital converters that convert sensor signals or intermediate conditioned signals into one or more digital values, for example, over time. In some embodiments, the data acquisition device 506 includes signal conditioning circuitry converts sensor signals into intermediate conditioned signals or another form for the one or more analog to digital converters to convert to digital values.

The thermal switch 508 includes a switch that changes a switch position, for example from open to closed and/or from closed to open, when a threshold temperature is reached or crossed.

The heater power supply 510 is a power supply that provides power for a heating component 120 (FIG. 1) of the thermal interface material testing device 100. While shown as a separate component from the thermal interface material testing device 100, the heater power supply 510 can also be a subcomponent of the thermal interface material testing device 100 (e.g., a subcomponent of the heating component 120).

The cooler power supply 512 is a power supply that provides power for a cooling component 122 (FIG. 1) of the thermal interface material testing device 100. While shown as a separate component from the thermal interface material testing device 100, the cooler power supply 512 can also be a subcomponent of the thermal interface material testing device 100 (e.g., a subcomponent of the cooling component 122). While shown as separate components, the heater power supply 510 and the cooler power supply 512 can be a single device and/or subcomponents of a power supply for the thermal cycling device 110 (FIG. 1).

The thermal interface material testing application 520 includes executable instructions such as one or more executable programs or services that control components of the thermal interface material testing system 500 for testing of a thermal interface material 104. For example, the thermal interface material testing application 520 controls thermal cycling of the bimaterial strip for a configurable number of cycles, receives and stores sensor data 522, generates thermal interface material data 524, and in some examples transmits the sensor data 522, thermal interface material data 524, and other thermal interface material testing data 530 to a networked computing device 504. In some embodiments, the thermal interface material testing application 520 electronically controls and configures components of the thermal interface material testing system 500 according to testing configuration data 526.

The sensor data 522 includes data generated based on sensor signals from various sensors of the thermal interface material testing device 100 and/or the thermal interface material testing system 500. Sensor data 522 includes imaging data from imaging devices including one or more of optical image devices, acoustic imaging devices, magnetic imaging devices and/or the like. The imaging data includes one or more timestamped two-dimensional or three-dimensional images that shows the thermal interface material 104, the bimaterial strip 102, and/or other components of the thermal interface material testing device 100. The sensor data 522 also includes temperature data from one or more thermocouples or other temperature sensors. Temperature data can indicate one or more timestamped temperatures for one or more locations of the thermal interface material 104, one or more locations of the bimaterial strip 102, and other items. The sensor data 522 also includes distance or displacement data for the thermal interface material 104, the bimaterial strip 102, and/or other components of the thermal interface material testing device 100.

The thermal interface material data 524 includes timestamped values for thermal interface material parameters including thermal resistance, thermal resistance increase (or change) over time, void percentages over time, voiding categories corresponding to one or more void percentage thresholds, and/or the like. The thermal interface material data 524 describes one or more qualities of a thermal interface material 104 at one or more times (and/or corresponding thermal cycles) of testing. Thermal resistance of the thermal interface material 104 can increase based on voiding, temperature, physical compression and/or expansion, and other factors associated with testing. The thermal interface material testing application 520 processes or analyzes the sensor data 522, including imaging data, temperature data, and and/or displacement data to generate the thermal interface material data 524.

The testing configuration data 526 includes information that describes how to assemble and operate a thermal interface material testing device 100 and other components of a thermal interface material testing system 500. Assembling includes physically constructing the thermal interface material testing device 100 and physically connecting the other components of the thermal interface material testing system 500. Operating includes programmatically controlling the thermal interface material testing system 500 to perform one or more tests for example, using the thermal interface material testing application 520. In some embodiments, the testing configuration data 526 includes the thermal interface material testing application 520 that operates the thermal interface material testing system 500 to perform one or more thermal interface material tests. The testing configuration data 526 includes information that describes how to use the thermal interface material testing system 500 to test various thermal interface materials 104 in association with a physical device component. The thermal interface material testing device 100 and the thermal interface material testing system 500 operate in concert to enable a bimaterial strip 102 to emulate or stand in for the device component.

The thermal interface material testing data 530 includes one or more of the thermal interface material testing application 520, imaging and/or other sensor data 522, thermal interface material data 524, and testing configuration data 526.

In some embodiments, the networked computing device 504 can represent a device operated by an enterprise such as a manufacturer, developer or provider of a device component that desires to test various thermal interface materials 104 in a standardized manner. The enterprise can design and store, in the networked computing device 504, testing configuration data 526 that describes how to assemble and operate a specified example of a thermal interface material testing device 100 and the thermal interface material testing system 500 for a physical device component.

The networked computing device 504 transmits and/or otherwise provides thermal interface material testing data 530 to one or more computing devices 502. A computing device 502 receives thermal interface material testing data 530 including one or more of the thermal interface material testing application 520, imaging and/or other sensor data 522, thermal interface material data 524, and testing configuration data 526. A person physically assembles the thermal interface material testing device 100 and the thermal interface material testing system 500 according to test design data included in the testing configuration data 526. A user executes the thermal interface material testing application 520 to perform a test of the thermal interface materials 104 in association with a device component.

In one example of the operation of the thermal interface material testing system 500, the computing device 502 executes the thermal interface material testing application 520 to perform a test that includes thermal cycling. The thermal interface material testing application 520 controls the heater power supply 510 to provide power to the heating component 120 of the thermal interface material testing device 100. The heating component 120 heats the bimaterial strip 102 and the thermal interface material 104. A temperature sensor such as a thermocouple of the thermal interface material testing device 100 provides temperature data to the thermal switch 508. Additionally, or alternatively, the temperature sensor provides temperature information to the data acquisition device 506. Once the temperature reaches an upper threshold temperature, for example, specified in the testing configuration data 526, the thermal switch 508 turns off or disconnects the heater power supply 510. Additionally, or alternatively, the data acquisition device 506 provides temperature data to the thermal interface material testing application 520. The thermal interface material testing application 520 stores the temperature data as sensor data 522. In some examples, the thermal interface material testing application 520 controls the thermal switch 508 or otherwise controls the heating component 120 to stop heating based on the upper level threshold temperature and the temperature data received from the temperature sensor.

The thermal interface material testing application 520 controls the cooler power supply 512 or otherwise controls a cooling component 122 to cool the bimaterial strip 102 and the thermal interface material 104 to a lower level threshold temperature specified in the testing configuration data 526. Once the temperature data from the temperature sensor indicates that the lower level threshold temperature is reached, the thermal interface material testing application 520 controls the cooler power supply 512 to stop cooling, completing one thermal cycle. The thermal interface material testing application 520 starts a next thermal cycle by again controlling the heater power supply 510 to provide power to the heating component 120, and continuing the as described above. The thermal interface material testing application 520 controls the thermal interface material testing system 500 to perform a configured number of thermal cycles.

As the thermal cycles are performed, the sensors of the thermal interface material testing device 100 provide information corresponding to imaging data, temperature data, displacement data, and other sensor data 522, to the data acquisition device 506 and/or the computing device 502. As indicated above, the thermal interface material testing application 520 uses the temperature data for feedback while controlling the thermal cycling process. The thermal interface material testing application 520 uses the imaging data, displacement data, and temperature data to generate the timestamped values for various parameters of thermal interface material data 524.

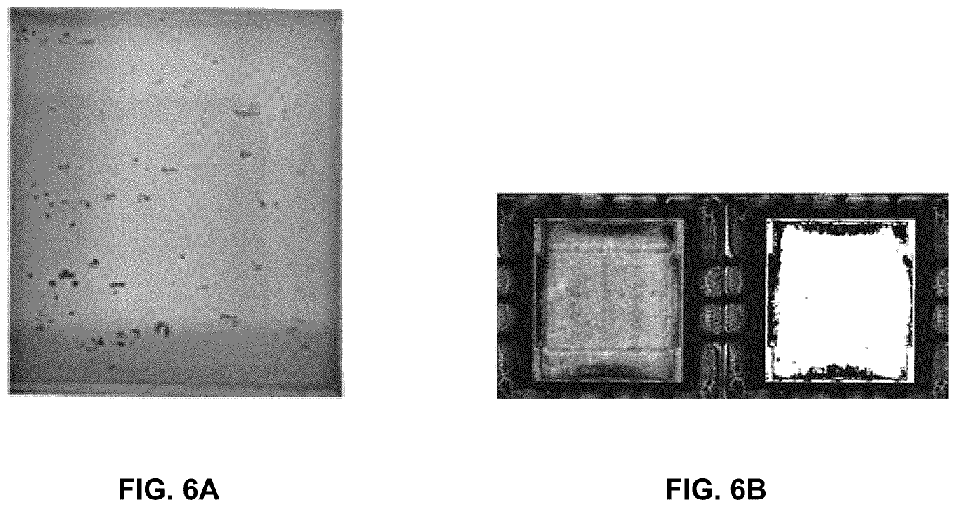

FIG. 6A illustrates exemplary image data generated using the thermal interface material testing device 100 of FIG. 1, according to various embodiments. FIG. 6A shows an image captured using an optical imaging device 112. In some embodiments, the image is captured through a transparent pressure plate 116 such as a quartz plate or other transparent or translucent optical imaging window that applies pressure against the thermal interface material 104. The image is stored as imaging or sensor data 522. The thermal interface material testing application 520 processes or analyzes the sensor data 522, including imaging data, temperature data, and and/or displacement data to generate the thermal interface material data 524. In some examples, the dark areas in the image represent void areas in the thermal interface material 104, while the lighter areas represent contact areas in the thermal interface material 104. The thermal interface material testing application 520 can analyze the image to identify void areas and contact areas using shading thresholds, contrasting edges, and other techniques. The thermal interface material testing application 520 uses the void areas and contact areas in one or more timestamped images to identify values for thermal interface material parameters including thermal resistance, thermal resistance increase (or change) over time, void percentages over time, voiding categories corresponding to one or more void percentage thresholds, and/or the like.

FIG. 6B illustrates exemplary image data image data generated using the thermal interface material tester of FIG. 5, according to various embodiments. FIG. 6B shows an example of a two-dimensional image (left) captured using a non-optical imaging device 402, and an increased-contrast version of the two-dimensional image (right). While this example shows a two-dimensional image, non-optical imaging devices 402 also generate three-dimensional representations of the thermal interface material 104 and components of the thermal interface material testing device 100. In some embodiments, the image is captured through a copper or other opaque pressure plate 404 that applies pressure against the thermal interface material 104. The images are stored as imaging or sensor data 522. The thermal interface material testing application 520 processes or analyzes the sensor data 522, including imaging data, temperature data, and and/or displacement data to generate the thermal interface material data 524. In some examples, the dark areas in the image represent void areas in the thermal interface material 104, while the lighter areas represent contact areas in the thermal interface material 104. The thermal interface material testing application 520 can analyze the images to identify void areas and contact areas using shading thresholds, contrasting edges, and other techniques. The thermal interface material testing application 520 uses the void areas and contact areas in one or more timestamped images to identify values for thermal interface material parameters including thermal resistance, thermal resistance increase (or change) over time, void percentages over time, voiding categories corresponding to one or more void percentage thresholds, and/or the like.

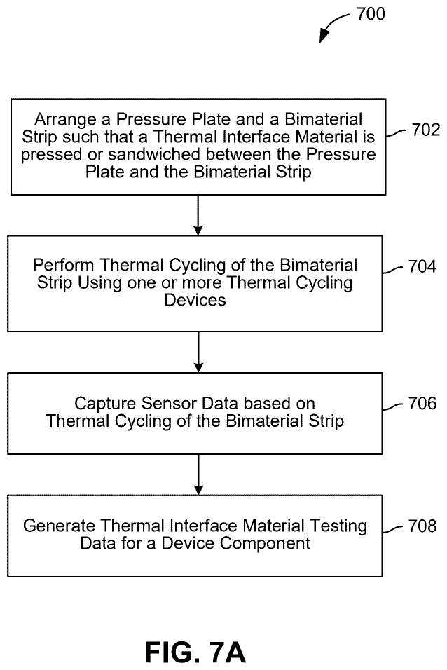

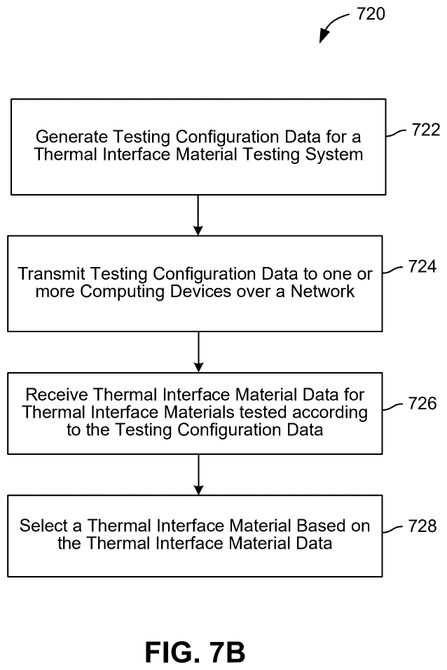

FIG. 7A is a flow diagram of method steps for generating thermal interface material testing data, according to various embodiments. Although the method steps are shown in an order, persons skilled in the art will understand that some method steps may be performed in a different order, repeated, omitted, and/or performed by components other than those described in FIG. 7A. Although the method steps are described with respect to the system of FIG. 5 and the devices of FIGS. 1-4, persons skilled in the art will understand that any system configured to perform the method steps, in any order, falls within the scope of the various embodiments.

As shown, a method 700 begins at step 702, where a pressure plate and a bimaterial strip 102 are arranged or assembled so that a thermal interface material 104 is pressed or sandwiched between the pressure plate and the bimaterial strip 102. In various embodiments, the pressure plate includes a transparent pressure plate 116 or an opaque pressure plate 404. A pressure plate assembly 106 including the pressure plate also includes one or more compression components 118. The bimaterial strip 102 emulates a physical device component. For example, in some embodiments the bimaterial strip 102 is utilized as a stand in for a chip, a die, and/or other electronic components that use a thermal interface material 104. In some embodiments, the bimaterial strip 102 is utilized as a stand in for a heatsink, a liquid cooling plate, and/or other thermal regulation components that use a thermal interface material 104. The pressure plate assembly 106 applies pressure that matches an expected pressure experienced by the physical device component in typical use.

At step 704, one or more thermal cycling devices 110 perform thermal cycling of the bimaterial strip 102 (and the thermal interface material 104). In some embodiments, a thermal interface material testing application 520 controls the one or more thermal cycling devices 110 to perform thermal cycling. In various embodiments, the one or more thermal cycling devices 110 include a heating component 120 and/or a cooling component 122. The heating component 120 and the cooling component 122 can be components of a single thermal cycling device 110, or separate thermal cycling devices 110 controlled in conjunction with one another to perform thermal cycling. As a result, one or more thermal cycling devices 110 of the thermal interface material testing device 100 heat and cool the bimaterial strip 102 to perform thermal cycling according to one or more thermal cycling parameters. The thermal cycling parameters for a test can match (or exceed) one or more temperature properties or parameters of a component that the bimaterial strip 102 emulates.

At step 706, one or more sensor devices capture sensor data 522 based on the thermal cycling of the bimaterial strip 102. The sensor data 522 includes data generated based on sensor signals from various sensors of the thermal interface material testing device 100 and/or the thermal interface material testing system 500. Sensor data 522 includes imaging data from imaging devices including one or more of optical image devices 112, non-optical imaging devices 402, and/or the like. The imaging data includes one or more timestamped two-dimensional or three-dimensional images that shows the thermal interface material 104, the bimaterial strip 102, and/or other components of the thermal interface material testing device 100. The sensor data 522 also includes temperature data from one or more thermocouples or other temperature sensors. Temperature data can indicate one or more timestamped temperatures for one or more locations of the thermal interface material 104, one or more locations of the bimaterial strip 102, and other items. The sensor data 522 also includes distance or displacement data for the thermal interface material 104, the bimaterial strip 102, and/or other components of the thermal interface material testing device 100.

At step 708, a computing device 502 generates thermal interface material data 524 for a device component. In one example, instructions executed using the computing device 502 processes or analyzes the sensor data 522, including imaging data, temperature data, and and/or displacement data to generate the thermal interface material data 524. The thermal interface material data 524 includes timestamped values for thermal interface material parameters including thermal resistance, thermal resistance increase (or change) over time, void percentages over time, voiding categories corresponding to one or more void percentage thresholds, and/or the like. The thermal interface material data 524 describes one or more qualities of a thermal interface material 104 at one or more times (and/or corresponding thermal cycles) of testing. Thermal resistance of the thermal interface material 104 can increase based on voiding, temperature, physical compression and/or expansion, and other factors associated with testing.

FIG. 7B is a flow diagram of method steps for selecting thermal interface materials 104 tested using the thermal interface material testing system 500 of FIG. 5, according to various embodiments. Although the method steps are shown in an order, persons skilled in the art will understand that some method steps may be performed in a different order, repeated, omitted, and/or performed by components other than those described in FIG. 7B. Although the method steps are described with respect to the system of FIG. 5, and the devices of FIGS. 1-4, persons skilled in the art will understand that any system configured to perform the method steps, in any order, falls within the scope of the various embodiments.

As shown, a method 720 begins at step 722, where the networked computing device 504 generates testing configuration data 526 for a thermal interface material testing system 500. The testing configuration data 526 includes information that describes how to assemble and operate a thermal interface material testing device 100 and other components of a thermal interface material testing system 500. In some embodiments, the testing configuration data 526 includes the thermal interface material testing application 520 that operates the thermal interface material testing system 500 to perform one or more thermal interface material tests. The testing configuration data 526 includes information that describes how to use the thermal interface material testing system 500 to test various thermal interface materials 104 in association with a physical device component.

At step 724, the networked computing device 504 transmits or otherwise provides the testing configuration data 526 to one or more computing devices 502 over a network. The one or more computing devices 502 receive and/or retrieve the testing configuration data 526. In one embodiment, the networked computing device 504 provides a programmatic interface such as an application programming interface that the one or more computing devices 502 invoke to retrieve the testing configuration data 526. The networked computing device 504 transmits the testing configuration data 526 based on the invocation of the programmatic interface. In another embodiment, the networked computing device 504 transmits the testing configuration data 526 in an electronic message such as an email message, hosts a webpage or website that provides the testing configuration data 526 for download, and/or the like.

At step 726, the networked computing device 504 receives thermal interface material data 524 for one or more thermal interface materials 104 that are tested based on the testing configuration data 526. The networked computing device 504 receives thermal interface material data 524 from one or more computing devices 502. In one embodiment, the networked computing device 504 provides a programmatic interface such as an application programming interface that the one or more computing devices 502 invoke using the thermal interface material data 524 as a parameter or payload. The networked computing device 504 receives and stores the thermal interface material data 524 based on the invocation of the programmatic interface. In another embodiment, the networked computing device 504 receives the thermal interface material data 524 in an electronic message such as an email message from the computing device 502, hosts a website or webpage that enables upload of thermal interface material data 524 from the computing device 502, and/or the like.

At step 728, the networked computing device 504 selects a thermal interface material 104 based on the thermal interface material data 524 corresponding to the thermal interface material 104. For example, the networked computing device 504 compares a plurality of thermal interface materials 104 based on various values for parameters in the thermal interface material data 524 to one or more threshold values, and selects one or more thermal interface materials 104 that are identified as suitable for use in association with a device component according to the threshold values. Additionally, or alternatively, the networked computing device 504 compares a plurality of thermal interface materials 104 based on corresponding values for a parameter in the thermal interface material data 524 and selects the thermal interface material 104 that has the most suitable (e.g., highest, lowest) value for the parameter.

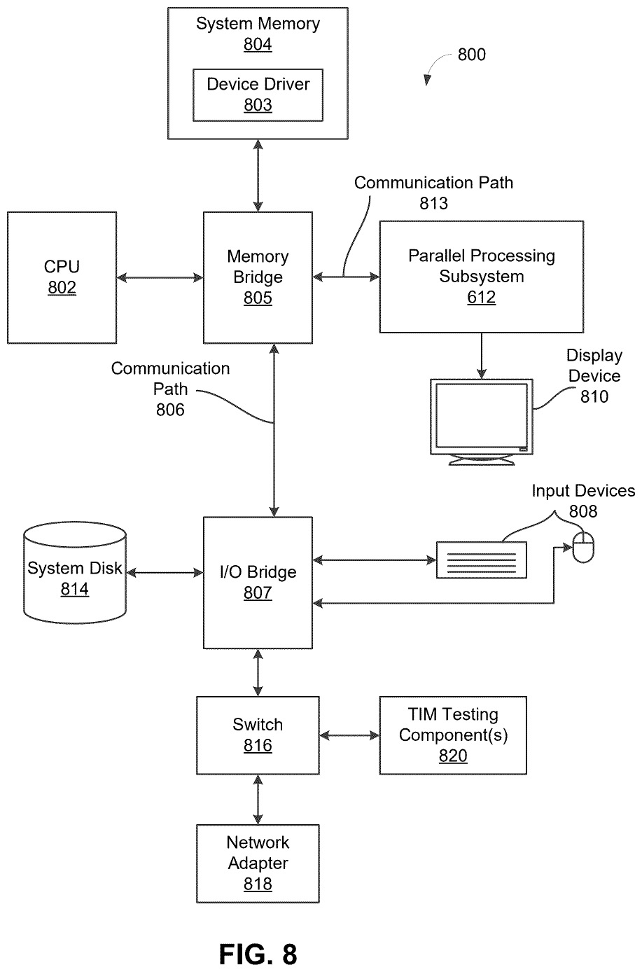

FIG. 8 is a block diagram illustrating a computer system 800 for use with the thermal interface material testing system of FIG. 5 and the thermal interface material testers of FIGS. 1 and 4, according to various embodiments. In some embodiments, computer system 800 is a machine or processing node operating in a data center, cluster, or cloud computing environment that provides scalable computing resources (optionally as a service) over a network. In some embodiments, the computer system 800 is a high-performance computing system or device such as, without limitation, a server machine, a server platform, a desktop machine, a laptop machine, a hand-held/mobile device, or a wearable device. The computer system 800 includes and/or is coupled to one or more power supplies that include one or more integrated inductor packages described herein, the power supplies provide power to one or more of the electronic components of the computer system 800.

In various embodiments, computer system 800 includes, without limitation, a central processing unit (CPU) 802 and a system memory 804 coupled to a parallel processing subsystem 812 via a memory bridge 805 and a communication path 813. Memory bridge 805 is further coupled to an I/O (input/output) bridge 807 via a communication path 806, and I/O bridge 807 is, in turn, coupled to a switch 816. In operation of the computer system 800, one or more of the CPU 802, the system memory 804, and/or the one or more parallel processing subsystems 812 can be coupled to and powered by a power supply.

In one embodiment, I/O bridge 807 is configured to receive user input information from optional input devices 808, such as a keyboard or a mouse, and forward the input information to CPU 802 for processing via communication path 806 and memory bridge 805. In some embodiments, computer system 800 may be a server machine in a cloud computing environment. In such embodiments, computer system 800 may not have input devices 808. Instead, computer system 800 may receive equivalent input information by receiving commands in the form of messages transmitted over a network and received via the network adapter 818. In one embodiment, switch 816 is configured to provide connections between I/O bridge 807 and other components of the computer system 800, such as a network adapter 818 and one or more thermal interface material testing components 820.

The one or more thermal interface material testing components 820 include any one or more of the components of the thermal interface material testing system 500, including, without limitation, a thermal interface material testing device 100, a computing device 502, a networked computing device 504, a data acquisition device 506, thermal switch 508, a heater power supply 510, a cooler power supply 512, and/or the like.

In one embodiment, I/O bridge 807 is coupled to a system disk 814 that may be configured to store content and applications and data for use by CPU 802 and parallel processing subsystem 812. In one embodiment, system disk 814 provides non-volatile storage for applications and data and may include fixed or removable hard disk drives, flash memory devices, and CD-ROM (compact disc read-only-memory), DVD-ROM (digital versatile disc-ROM), Blu-ray, HD-DVD (high definition DVD), or other magnetic, optical, or solid state storage devices. In various embodiments, other components, such as universal serial bus or other port connections, compact disc drives, digital versatile disc drives, film recording devices, and the like, may be coupled to I/O bridge 807 as well.

In various embodiments, memory bridge 805 may be a Northbridge chip, and I/O bridge 807 may be a Southbridge chip. In addition, communication paths 806 and 813, as well as other communication paths within computer system 800, may be implemented using any technically suitable protocols, including, without limitation, AGP (Accelerated Graphics Port), HyperTransport, or any other bus or point-to-point communication protocol known in the art.

In some embodiments, parallel processing subsystem 812 includes a graphics subsystem that delivers pixels to an optional display device 810 that may be any conventional cathode ray tube, liquid crystal display, light-emitting diode display, or the like. In such embodiments, the parallel processing subsystem 812 incorporates circuitry optimized for graphics and video processing, including, for example, video output circuitry. Such circuitry may be incorporated across one or more parallel processing units (PPUs), also referred to herein as parallel processors, included within parallel processing subsystem 812. In other embodiments, the parallel processing subsystem 812 incorporates circuitry optimized for general purpose and/or compute processing. Again, such circuitry may be incorporated across one or more PPUs included within parallel processing subsystem 812 that are configured to perform such general purpose and/or compute operations. In yet other embodiments, the one or more PPUs included within parallel processing subsystem 812 may be configured to perform graphics processing, general purpose processing, and compute processing operations. System memory 804 includes at least one device driver 803 configured to manage the processing operations of the one or more PPUs within parallel processing subsystem 812.

In various embodiments, parallel processing subsystem 812 may be integrated with one or more of the other elements of FIG. 6 to form a single system. For example, parallel processing subsystem 812 may be integrated with CPU 802 and other connection circuitry on a single chip to form a system on chip (SoC).

In one embodiment, CPU 802 is the master processor of computer system 800, controlling and coordinating operations of other system components. In one embodiment, CPU 802 issues commands that control the operation of PPUs. In some embodiments, communication path 813 is a Peripheral Component Interconnect (PCI) or PCI Express link, in which dedicated lanes are allocated to each PPU, as is known in the art. The one or more parallel processing subsystems 812 can include one or more PCI Express cards such as converged cards and/or other peripheral cards that fit within a standardized spacing for a single PCI Express slot or another type of standardized spacing for a slot of a server and/or computer architecture.

The one or more parallel processing subsystems 812 can implement one or more of the cooling techniques described herein with respect to FIGS. 1-5. Other communication paths may also be used. PPU advantageously implements a highly parallel processing architecture. A PPU may be provided with any amount of local parallel processing memory (PP memory).

It will be appreciated that the system shown herein is illustrative and that variations and modifications are possible. The connection topology, including the number and arrangement of bridges, the number of CPUs 802, and the number of parallel processing subsystems 812, may be modified as desired. For example, in some embodiments, system memory 804 could be coupled to CPU 802 directly rather than through memory bridge 805, and other devices would communicate with system memory 804 via memory bridge 805 and CPU 802. In other embodiments, parallel processing subsystem 812 may be coupled to I/O bridge 807 or directly to CPU 802, rather than to memory bridge 805. In still other embodiments, I/O bridge 807 and memory bridge 805 may be integrated into a single chip instead of existing as one or more discrete devices. In certain embodiments, one or more components shown in FIG. 6 may not be present. For example, switch 816 could be eliminated, and network adapter 818 and/or thermal interface material testing components 820 would connect directly to I/O bridge 807.

In sum, techniques are disclosed for techniques for thermal interface material testing. One embodiment of the present disclosure sets forth a thermal interface material testing system that includes a pressure plate, a bimaterial strip, a thermal interface material between the pressure plate and the bimaterial strip, one or more thermal cycling devices that perform thermal cycling of the bimaterial strip to test the thermal interface material, and one or more sensor devices that generate sensor data based on the thermal cycling of the bimaterial strip.

Further embodiments of the present disclosure set forth a thermal interface material testing device, that includes a bimaterial strip, a pressure plate that applies a pressure to a thermal interface material between the pressure plate and the bimaterial strip, one or more thermal cycling devices that perform thermal cycling of the bimaterial strip to test the thermal interface material, and one or more sensor devices that generate sensor data based on the thermal cycling of the bimaterial strip.

Further embodiments of the present disclosure set forth a method that includes generating thermal interface material testing configuration data including instructions to assemble and operate a thermal interface material testing device to test thermal interface materials, where the thermal interface material testing device comprises a pressure plate, a bimaterial strip, one or more thermal cycling devices, and one or more sensor devices; and transmitting the thermal interface material testing configuration data to one or more networked computing devices, for example, to perform tests for one or more thermal interface materials.

At least one technical advantage of the disclosed techniques relative to the prior art is that the disclosed techniques enable the suitability of a thermal interface material for an electronic component or thermal regulation component to be tested without using the physical component. The disclosed techniques further enable multiple thermal interface materials to be tested in parallel, for example, prior to a production phase of the physical component. The disclosed techniques further enable thermal interface materials to be tested by any number of enterprises in relation to the physical component without exposing the physical component to security risks such as reverse engineering. These technical advantages represent one or more technological improvements over prior art approaches

The following clauses describe some embodiments of the present disclosure.
1. In some embodiments, a thermal interface material testing system comprises a pressure plate, a bimaterial strip, a thermal interface material between the pressure plate and the bimaterial strip, one or more thermal cycling devices that perform thermal cycling of the bimaterial strip to test the thermal interface material, and one or more sensor devices that generate sensor data based on the thermal cycling of the bimaterial strip.
2. The thermal interface material testing system of clause 1, further comprising a computing device that receives the sensor data and generates thermal interface material data based on the sensor data.
3. The thermal interface material testing system of clauses 1 or 2, wherein the bimaterial strip is a bimetallic strip comprising two different metals.
4. The thermal interface material testing system of any of clauses 1-3, wherein the sensor data comprises at least one of two-dimensional image data or three-dimensional image data that depicts the thermal interface material.
5. The thermal interface material testing system of any of clauses 1-4, wherein the pressure plate comprises a quartz pressure plate, and the one or more sensor devices comprise one or more optical imaging devices.
6. The thermal interface material testing system of any of clauses 1-5, wherein the pressure plate comprises a copper pressure plate, and the one or more sensor devices comprise one or more non-optical imaging devices.
7. The thermal interface material testing system of any of clauses 1-6, wherein the thermal cycling comprises one or more thermal cycles comprising heating, using the one or more thermal cycling devices, the bimaterial strip to a first configured temperature, and cooling, using the one or more thermal cycling devices, the bimaterial strip to a second configured temperature.
8. The thermal interface material testing system of any of clauses 1-7, wherein the one or more sensor devices comprise one or more of a temperature sensor that measures a temperature of the bimaterial strip or a displacement sensor that measures displacement of the bimaterial strip.
9. The thermal interface material testing system of any of clauses 1-8, wherein the bimaterial strip emulates a physical component, and an upper level temperature of the thermal cycling is based on one or more operational limits of the physical component.
10. The thermal interface material testing system of any of clauses 1-9, wherein the bimaterial strip emulates a physical component, and an upper level temperature of the thermal cycling exceeds one or more operational limits of the physical component.
11. In some embodiments, a thermal interface material testing device comprises a bimaterial strip, a pressure plate that applies a pressure to a thermal interface material between the pressure plate and the bimaterial strip, one or more thermal cycling devices that perform thermal cycling of the bimaterial strip to test the thermal interface material, and one or more sensor devices that generate sensor data based on the thermal cycling of the bimaterial strip.
12. The thermal interface material testing device of clause 11, wherein the pressure matches an expected pressure for a device component emulated using the bimaterial strip.
13. The thermal interface material testing device of clauses 11 or 12, wherein the sensor data comprises temperature data measured using one or more temperature sensors.
14. The thermal interface material testing device of any of clauses 11-13, wherein the sensor data comprises at least one of two-dimensional image data or three-dimensional image data that depicts the thermal interface material.
15. The thermal interface material testing device of any of clauses 11-14, wherein the pressure plate comprises a transparent pressure plate or a translucent pressure plate.
16. The thermal interface material testing device of any of clauses 11-15, wherein the pressure plate comprises an opaque pressure plate.
17. The thermal interface material testing device of any of clauses 11-16, wherein the thermal cycling comprises one or more thermal cycles comprising heating, using the one or more thermal cycling devices, the bimaterial strip to a first configured temperature, and cooling, using the one or more thermal cycling devices, the bimaterial strip to a second configured temperature.
18. In some embodiments, a method comprises generating thermal interface material testing configuration data comprising instructions to assemble and operate a thermal interface material testing device to test thermal interface materials, wherein the thermal interface material testing device comprises a pressure plate, a bimaterial strip, one or more thermal cycling devices, and one or more sensor devices, and transmitting the thermal interface material testing configuration data to one or more networked computing devices.
19. The method of clause 18, further comprising receiving thermal interface material data corresponding to a plurality of thermal interface materials tested based on the thermal interface material testing configuration data.
20. The method of clauses 18 or 19, further comprising selecting, based on the thermal interface material data, one or more thermal interface materials for use in association with a device component emulated using the bimaterial strip.

Any and all combinations of any of the claim elements recited in any of the claims and/or any elements described in this application, in any fashion, fall within the contemplated scope of the present disclosure and protection.

The descriptions of the various embodiments have been presented for purposes of illustration but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module” or “system.” Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A thermal interface material testing system, comprising:
a pressure plate;
a bimaterial strip;
a thermal interface material between the pressure plate and the bimaterial strip;
one or more thermal cycling devices that perform thermal cycling of the bimaterial strip to test the thermal interface material; and
one or more sensor devices that generate sensor data based on the thermal cycling of the bimaterial strip.

2. The thermal interface material testing system of claim 1, further comprising a computing device that receives the sensor data and generates thermal interface material data based on the sensor data.

3. The thermal interface material testing system of claim 1, wherein the bimaterial strip is a bimetallic strip comprising two different metals.

4. The thermal interface material testing system of claim 1, wherein the sensor data comprises at least one of two-dimensional image data or three-dimensional image data that depicts the thermal interface material.

5. The thermal interface material testing system of claim 1, wherein the pressure plate comprises a quartz pressure plate, and the one or more sensor devices comprise one or more optical imaging devices.

6. The thermal interface material testing system of claim 1, wherein the pressure plate comprises a copper pressure plate, and the one or more sensor devices comprise one or more non-optical imaging devices.

7. The thermal interface material testing system of claim 1, wherein the thermal cycling comprises one or more thermal cycles comprising:
heating, using the one or more thermal cycling devices, the bimaterial strip to a first configured temperature; and
cooling, using the one or more thermal cycling devices, the bimaterial strip to a second configured temperature.

8. The thermal interface material testing system of claim 1, wherein the one or more sensor devices comprise one or more of a temperature sensor that measures a temperature of the bimaterial strip or a displacement sensor that measures displacement of the bimaterial strip.

9. The thermal interface material testing system of claim 1, wherein the bimaterial strip emulates a physical component, and an upper level temperature of the thermal cycling is based on one or more operational limits of the physical component.

10. The thermal interface material testing system of claim 1, wherein the bimaterial strip emulates a physical component, and an upper level temperature of the thermal cycling exceeds one or more operational limits of the physical component.

11. A thermal interface material testing device, comprising:
a bimaterial strip;
a pressure plate that applies a pressure to a thermal interface material between the pressure plate and the bimaterial strip;
one or more thermal cycling devices that perform thermal cycling of the bimaterial strip to test the thermal interface material; and
one or more sensor devices that generate sensor data based on the thermal cycling of the bimaterial strip.

12. The thermal interface material testing device of claim 11, wherein the pressure matches an expected pressure for a device component emulated using the bimaterial strip.

13. The thermal interface material testing device of claim 11, wherein the sensor data comprises temperature data measured using one or more temperature sensors.

14. The thermal interface material testing device of claim 11, wherein the sensor data comprises at least one of two-dimensional image data or three-dimensional image data that depicts the thermal interface material.

15. The thermal interface material testing device of claim 11, wherein the pressure plate comprises a transparent pressure plate or a translucent pressure plate.

16. The thermal interface material testing device of claim 11, wherein the pressure plate comprises an opaque pressure plate.

17. The thermal interface material testing device of claim 11, wherein the thermal cycling comprises one or more thermal cycles comprising:
heating, using the one or more thermal cycling devices, the bimaterial strip to a first configured temperature; and
cooling, using the one or more thermal cycling devices, the bimaterial strip to a second configured temperature.

18. A method, comprising:
generating thermal interface material testing configuration data comprising instructions to assemble and operate a thermal interface material testing device to test thermal interface materials, wherein the thermal interface material testing device comprises a pressure plate, a bimaterial strip, one or more thermal cycling devices, and one or more sensor devices; and
transmitting the thermal interface material testing configuration data to one or more networked computing devices.

19. The method of claim 18, further comprising:
receiving thermal interface material data corresponding to a plurality of thermal interface materials tested based on the thermal interface material testing configuration data.

20. The method of claim 19, further comprising:
selecting, based on the thermal interface material data, one or more thermal interface materials for use in association with a device component emulated using the bimaterial strip.
